(19) United States
(12) Patent Application Publication
(10) Pub. No.: US 2010/0254214 A1
(43) Pub. Date: Oct. 7, 2010

(54) Methods and Systems for Slurry Blending

(76) Inventors: Chad A. Fisher, Duncan, OK (US); Wesley J. Warren, Duncan, OK (US)

Correspondence Address: JOHN W. WUSTENBERG, P.O. BOX 1431, DUNCAN, OK, 73536, US

(21) Appl. No.: 12/416,729

(22) Filed: Apr. 1, 2009

(51) Int. Cl. B01F 15/02; B01F 15/04

(52) U.S. Cl. 366/152.2; 366/182.2

(57) ABSTRACT

Methods and systems for blending fluids used in subterranean operations are disclosed. A first portion of a fluid component of the slurry is passed through a non-slurry pump in a first process line. A second portion of the fluid component of the slurry is passed to a mixing tub in a second process line. A solid component is added to the second portion of the fluid component of the slurry in the mixing tub. The second portion of the fluid component of the slurry is mixed with the solid component in the mixing tub so that the second portion of the fluid component of the slurry has a higher concentration than a desired downhole concentration. The output of the mixing tub is pumped through a slurry pump. The output of the slurry pump is diluted by adding the first portion of the fluid component of the slurry from the first process line and the diluted mixture is directed to a high pressure pump.

### BACKGROUND

The present invention relates to blending operations and, more particularly, to methods and systems for blending fluids used in subterranean operations.

Oil field operations often involve the blending of dry materials with a fluid. For instance, dry materials may be added to a fluid when preparing a fracturing fluid, a drilling fluid or other slurries utilized in subterranean operations. High pressure pumps are then used to pump the slurry to a desired location downhole.

The fluid and the dry material are added to a mixing tub and mixed to create the desired slurry. In conventional methods, the ratio of the fluid and the solid material added to the mixing tub is controlled so that the slurry that exits the mixing tub has the concentration desired downhole. The conventional methods of making slurries have several disadvantages. For instance, depending on the job rate, the equipment needed (e.g., the mixing tub, the tub level valve, the slurry pump, etc.) for creating the mixture are often bulky and consume a large amount of energy.

More recent methods such as that disclosed in U.S. application Ser. No. 12/151,499, assigned to Halliburton Energy Services, Inc., and referred to as “Split Fluid Flow” methods involve an improved process whereby the slurry created in the mixing tub has a concentration higher than that desired downhole. The concentrated mixture is then diluted before being pumped downhole to achieve the concentration desired downhole. The “Split-Flow” methods reduce the size of the components required for the slurry fluid system such as the mixing tub, the tub level valve, the slurry pump and the tub fill pump. Moreover, the “Split-Flow” methods reduce the power consumption of the system since less fluid is throttled across the tub level valve and the non-slurry pump used to dilute the concentrated mixture operates more efficiently than a slurry pump.

However, because the current “Split Fluid Frac” methods entail the use of separate equipment for the non-slurry fluid and the slurry concentrate, they often have a large footprint, which is a drawback considering the limited space availability at the well site which could be located off shore or on shore. Additionally, the use of separate equipment increases the number of fluid connections and wiring for the sensors and controls of components that must be connected at the well site. Finally, having the non-slurry pump as a separate piece of equipment means that the non-slurry pump must be separately transported to the well site, therefore requiring its own prime mover (diesel engine) that must be maintained.

### SUMMARY

The present invention relates to blending operations and, more particularly, to methods and systems for blending fluids used in subterranean operations.

In one exemplary embodiment, the present invention is directed to a method of blending a slurry comprising: passing a first portion of a fluid component of the slurry through a non-slurry pump in a first process line; passing a second portion of the fluid component of the slurry to a mixing tub in a second process line; adding a solid component to the second portion of the fluid component of the slurry in the mixing tub; mixing the second portion of the fluid component of the slurry with the solid component in the mixing tub so that the second portion of the fluid component of the slurry has a higher concentration than a desired downhole concentration; pumping an output of the mixing tub through a slurry pump; diluting the output of the slurry pump by adding the first portion of the fluid component of the slurry from the first process line; and directing the diluted mixture to a high pressure pump.

In another exemplary embodiment, the present invention is directed to a slurry blending system comprising: a first process line comprising a non-slurry pump; and a second process line comprising a mixing tub coupled to a slurry pump; wherein an output of the first process line is selectively couplable to an output of the slurry pump at an output of the slurry blending system; and wherein an output of the slurry blending system is directed to a high pressure pump.

In yet another exemplary embodiment, the present invention is directed to a slurry blending system comprising: a first process line comprising a non-slurry pump; a second process line comprising a tub fill pump, a mixing tub and a slurry pump; wherein an output of the first process line is selectively couplable to an output of the second process line; and a bypass line connecting an output of the first process line to an output of the tub fill pump in the second process line, wherein the bypass line is operable to allow a fluid flowing through the second process line to bypass the mixing tub and the slurry pump.

The features and advantages of the present invention will be apparent to those skilled in the art from the description of the preferred embodiments, which follows, when taken in conjunction with the accompanying drawings. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 is a diagram of a slurry blending system in accordance with an exemplary embodiment of the present invention.

While embodiments of this disclosure have been depicted and described and are defined by reference to example embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present invention relates to blending operations and, more particularly, to methods and systems for blending fluids used in subterranean operations.

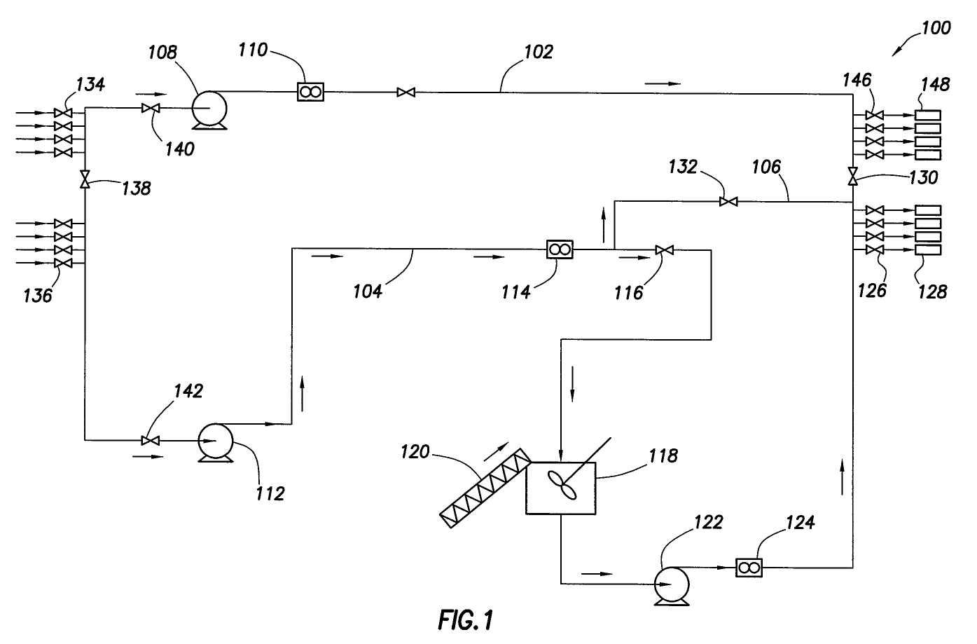

Turning now to FIG. 1, a blending apparatus in accordance with an exemplary embodiment of the present invention is denoted generally with reference numeral 100. The blending apparatus 100 is designed so as to allow conventional and Split-Flow blending operations in a single unit. The blending apparatus includes a first process line 102 and a second process line 104 with a bypass line 106 connecting the two. The first process line 102 may be coupled to one or more fluid tanks (not shown) through the input valves 134. Similarly, the second process line 104 may be coupled to one or more fluid tanks (not shown) though the input valves 136. A valve 138 may be used to control fluid communication between the input valves 134 of the first process line 102 and the input valves 136 of the second process line 104. The first process line 102 includes a non-slurry pump 108 and a flowmeter 110. As would be appreciated by those of ordinary skill in the art, with the benefit of this disclosure, a number of valves may be used to control fluid flow through the blending apparatus. For instance, the valve 140 may be used to control fluid flow through the non-slurry pump 108. The second process line 104 includes a tub fill pump 112, a flowmeter 114, a tub level valve 116 and a mixing tub 118. A valve 142 may be used to control fluid flow through the tub fill pump 112. The solid component(s) of the slurry may be added to the mixing tub 118 from a solid material metering device 120. The solid component may be proppants (e.g., sand, sintered bauxite, or ceramic), diverting agents (e.g., rock salt), fluid loss materials (e.g., silica flour) or other suitable solid materials, depending on the operations at hand. Similarly, a wide range of fluids may be used, depending on the operations at hand. In one exemplary embodiment, the present methods and systems may be used in fracturing operations. In this embodiment, the fluid used may be a water based or a hydrocarbon based fracturing fluid or a fresh or a recycled fluid. Additionally, the fracturing fluid may contain chemicals or polymers for increased viscosity or friction reduction and may be either cross linked or linear. In another exemplary embodiment, the methods and systems disclosed may be used in acidizing operations where the fluid used may be an acidizing fluid.

The second process line 104 further includes a slurry pump 122 to pump the slurry coming out of the mixing tub 118 through a flowmeter 124. Output valves 126 may direct the fluid output from the second process line 104 of the blending apparatus 100 to one or more high pressure pumps 128 which pump the slurry downhole. Similarly, output valves 146 may direct the fluid output from the first process line 102 of the blending apparatus 100 to one or more high pressure pumps 148 which pump the output of the first process line 102 downhole. A valve 130 may be operable to selectively couple the output of the first process line 102 to the output of the second process line 104. When the valve 130 is open, the output of the first process line 102 is mixed with the output of the second process line 104 and the mixture may be passed to one or more of the high pressure pumps 128, 148 by controlling the output valves 126, 146. The blending apparatus 100 provides a flexible mechanism with a small footprint, which may be used in a number of different modes of operation depending on the job requirements.

In a first mode of operation, the blending apparatus 100 may be used in conventional blending operations where the job rate is less than the maximum rate of the slurry pump 122. In this embodiment, the first process line 102 may remain unused. The tub fill pump 112 is a low pressure pump which pumps the fluid portion of the slurry from a fluid tank (not shown) through the flowmeter 114 to the tub level valve 116. The tub level valve 116 controls the flow of fluid to the mixing tub 118. Solid materials are then added to the mixing tub 118 from the solid material metering device 120. The amount of the fluid and the solid materials is controlled so that the resulting slurry exiting the mixing tub 118 is at the desired downhole concentration. The slurry pump 122 then pumps the resulting slurry through the flowmeter 124 and the valves 126 to the high pressure pumps 128 which in turn pump the slurry downhole. As would be appreciated by those of ordinary skill in the art, depending on the job requirements, the valves 130, 146 may be opened or closed to control the flow through the high pressure pumps 148.

In another mode of operation, the blending apparatus 100 may be used in conventional blending operations where the job rate is greater than the maximum rate of the tub fill pump 112, flowmeter 114, tub fill valve 116, mixing tub 118, and/or slurry pump 122. In this mode of operation, the second process line 104 cannot by itself meet the job requirements. As a result, the first process line 102 and the second process line 104 operate in conjunction with one another to meet the job requirements. In the second process line 104, the tub fill pump 112 pumps a portion of the fluid part of the slurry through the flowmeter 114 and the tub level valve 116 to the mixing tub 118. As in the previous mode of operation, solid materials are then added to the mixing tub 118 from the solid material metering device 120. However, in this mode of operation the amount of the fluid portion and the solid materials is controlled so that the resulting slurry exiting the mixing tub 118 has a concentration greater than the desired downhole concentration. In the meantime, the non-slurry pump 108 of the first process line 102 pumps additional fluid from the fluid tanks (not shown) through the flowmeter 110. In this mode of operation, the valve 130 is opened to allow fluid communication between the first process line 102 and the second process line 104. As a result, the additional fluid from the first process line 102 is added to the concentrated slurry from the slurry pump 122 to create a slurry having the desired downhole concentration. The slurry having the desired downhole concentration may be then directed to one or more high pressure pumps 128, 148 through the output valves 126, 146. Hence, the utilization of the first process line 102 and the second process line 104 in this mode of operation meets the job requirements despite the tub fill pump 112, flowmeter 114, tub fill valve 116, mixing tub 118, and/or slurry pump 122 having a rate lower than the desired job rate.

In yet another mode of operation, the blending apparatus 100 may be used in Split Fluid Frac operations. This mode of operation may be utilized because the second process line 104 cannot by itself meet the job requirements. Alternatively, Split Fluid Frac may be the preferred mode of operation due to operational reasons external to the blender. As a result, the first process line 102 and the second process line 104 operate in conjunction with one another to meet the job requirements. In the second process line 104, the tub fill pump 112 pumps the fluid part of the slurry through the flowmeter 114 and the tub level valve 116 to the mixing tub 118. The solid materials are then added to the mixing tub 118 from the solid material metering device 120. The amount of the fluid portion and the solid materials is controlled so that the resulting slurry exiting the mixing tub 118 has a concentration greater than the desired downhole concentration. In the mean time, the non-slurry pump 108 of the first process line 102 pumps the fluid portion of the slurry from the fluid tanks (not shown) through the flowmeter 110. In this mode of operation, the valve 130 remains closed. The concentrated slurry from the slurry pump 122 passes through the flowmeter 124 and reaches a first group (in this example, those below the valve 130) of the high pressure pumps 128 through the output valves 126. The non-slurried portion of the fluid is delivered to a second group (in this example, those above the valve 130) of the high pressure pumps 148 through the output valves 146. After passing through the high pressure pumps 148, the fluid portion of the slurry from the first process line 102 is combined with the concentrated slurry from the second process line 104 to form a slurry having the desired downhole concentration.

In one exemplary embodiment, a bypass line 106 is provided which may be used to bypass the tub level valve 116, the mixing tub 118 and the slurry pump 122 in the second process line 104. In one exemplary embodiment, a valve 132 may be used in conjunction with the tub level valve 116 to control the flow through the bypass line 106. The bypass line 106 may be utilized in instances where it is desirable to use the tub fill pump 112 to pump a non-slurry fluid to the high pressure pumps 128. For instance, it may be desirable to bypass the tub level valve 116, the mixing tub 118 and the slurry pump 122 if one or more of these components fail before job completion. Additionally, the bypass line 106 may be used in instances where a job requires a distinct transition between the slurry and the non-slurry fluids at the completion of the job. For example, as would be appreciated by those of ordinary skill in the art, with the benefit of this disclosure, the well bore must be cleaned of slurries when performing wire line or coil tubing operations therein. For some higher job rates, the bypass line 106 is used to allow the tub fill pump 112 to work in conjunction with the non-slurry pump 108 to meet job requirements.

As would be appreciated by those of ordinary skill in the art, having the mixing tub, the slurry pump and the non-slurry pump in the same unit at the well site has several advantages. First, as discussed above, the disclosed arrangement provides a flexible device capable of multiple desirable modes of operation. Moreover, combining these three components will reduce the footprint in the field and reduce the system's power consumption. Additionally, the improved methods and systems disclosed reduce the number of pieces of equipment necessary in the field. Therefore, fewer pieces of equipment are transported to the well site, fewer connection must be made at the well site and there are fewer prime movers to maintain.

As would be appreciated by those of ordinary skill in the art, with the benefit of this disclosure, although a limited number of flowmeters and valves are indicated, additional valves or flowmeters may be used throughout the system to help with directing and monitoring the flow of fluids or slurries in the process lines.

Therefore, the present invention is well-adapted to carry out the objects and attain the ends and advantages mentioned as well as those which are inherent therein. While the invention has been depicted and described by reference to exemplary embodiments of the invention, such a reference does not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects. The terms in the claims have their plain, ordinary meaning unless otherwise explicitly and clearly defined by the patentee.

What is claimed is:

1. A method of blending a slurry comprising:
passing a first portion of a fluid component of the slurry through a non-slurry pump in a first process line;
passing a second portion of the fluid component of the slurry to a mixing tub in a second process line;
adding a solid component to the second portion of the fluid component of the slurry in the mixing tub;
mixing the second portion of the fluid component of the slurry with the solid component in the mixing tub so that the second portion of the fluid component of the slurry has a higher concentration than a desired downhole concentration;
pumping an output of the mixing tub through a slurry pump;
diluting an output of the slurry pump by adding the first portion of the fluid component of the slurry from the first process line; and
directing the diluted mixture to a high pressure pump.

2. The method of claim 1, wherein the step of diluting the output of the slurry pump comprises adding a sufficient amount of the first portion of the fluid component of the slurry from the first process line to achieve a desired downhole concentration.

3. The method of claim 1, wherein the fluid component of the slurry is selected from the group consisting of a fracturing fluid, an acidizing fluid, and combinations thereof.

4. The method of claim 1, wherein the solid component of the slurry is selected from the group consisting of a proppant, a diverting agent, a fluid loss material, and combinations thereof.

5. The method of claim 4, wherein the proppant is selected from the group consisting of sand, sintered bauxite, ceramic, and combinations thereof.

6. The method of claim 4, wherein the diverting agent comprises a rock salt.

7. The method of claim 4, wherein the fluid loss material comprises silica flour.

8. The method of claim 1, wherein the high pressure pump comprises a positive displacement pump.

9. The method of claim 1, wherein the solid component is added to the mixing tub from a solid material metering device.

10. A slurry blending system comprising:
a first process line comprising a non-slurry pump; and
a second process line comprising a mixing tub coupled to a slurry pump;
wherein an output of the first process line is selectively couplable to an output of the slurry pump at an output of the slurry blending system; and
wherein an output of the slurry blending system is directed to a high pressure pump.

11. The slurry blending system of claim 10, wherein a fluid flowing through the first process line is combined with a fluid flowing through the second process line before the output of the slurry blending system is directed to the high pressure pump.

12. The slurry blending system of claim 10, wherein the high pressure pump comprises one or more positive displacement pumps.

13. The slurry blending system of claim 10, wherein the second process line further comprises a tub fill pump which supplies fluid to the mixing tub.

14. The slurry blending system of claim 13, further comprising a bypass line;
wherein the bypass line connects the tub fill pump to the output of the first process line, bypassing the mixing tub and the slurry pump of the second process line;
wherein the tub fill pump is operable to pump a fluid to the output of the first process line through the bypass line.

15. The slurry blending system of claim 13, further comprising a tub fill valve; wherein the tub fill valve is positioned between the tub fill pump and the mixing tub.

16. The slurry blending system of claim 10, further comprising one or more flowmeters to monitor fluid flow through the first process line and the second process line.

17. The slurry blending system of claim 10, wherein the mixing tub has a fluid input from the tub fill pump and a solid material input from a solid material metering device.

18. The slurry blending system of claim 18, wherein the fluid input is selected from the group consisting of a fracturing fluid and an acidizing fluid.

19. The slurry blending system of claim 18, wherein the solid material input is selected from the group consisting of a proppant, a diverting agent, a fluid loss material, and combinations thereof.

20. A slurry blending system comprising:
a first process line comprising a non-slurry pump;
a second process line comprising a tub fill pump, a mixing tub and a slurry pump;
wherein an output of the first process line is selectively couplable to an output of the second process line; and
a bypass line connecting an output of the first process line to an output of the tub fill pump in the second process line,
wherein the bypass line is operable to allow a fluid flowing through the second process line to bypass the mixing tub and the slurry pump.
